(19) United States
(12) Patent Application Publication
(10) Pub. No.: US 2013/0185170 A1
(43) Pub. Date: Jul. 18, 2013

(54) GIFT RECOMMENDATION METHOD AND SYSTEM

(71) Applicants: Xiaoyuan Wu, Shanghai (CN); Qian Sun, San Jose, CA (US); Qiang Wang, Shanghai (CN); Yang Zhou, Shanghai (CN)

(72) Inventors: Xiaoyuan Wu, Shanghai (CN); Qian Sun, San Jose, CA (US); Qiang Wang, Shanghai (CN); Yang Zhou, Shanghai (CN)

(73) Assignee: EBAY INC., San Jose, CA (US)

(21) Appl. No.: 13/789,992

(22) Filed: Mar. 8, 2013

Related U.S. Application Data
(63) Continuation of application No. 12/346,718, filed on Dec. 30, 2008.

(51) Int. Cl. G06Q 30/06

(52) U.S. Cl. CPC G06Q 30/0631
USPC 705/26.7

(57) ABSTRACT

Embodiments for recommending gifts to users for their gift recipients over a network are described. The gift recommendation system may retrieve gender and age information of a gift recipient, for example, via a graphical user interface, and then may automatically present to the user a list of predetermined number of gift categories selected based on the gender and age information of the gift recipient. Once a gift category is selected from the presented list of predetermined amount of gift categories, the gift recommendation system may automatically present to the user a list of gift items belonging to the respective selected gift categories.

### CLAIM OF PRIORITY

This application is a continuation of U.S. Application No. 12/346,718 filed Dec. 30, 2008 entitled, “GIFT RECOMMENDATION METHOD AND SYSTEM,” which is incorporated herein by reference in its entirety.

### TECHNICAL FIELD

The present application relates to methods and systems for conducting electronic commerce activities over a network.

### BACKGROUND

With the development of computer and network related technologies, more users communicate over networks and participate in electronic commerce activities, e.g. finding and/or purchasing gifts for their gift recipients (e.g., friends) via networks. However, it is a time consuming task for users to find unique and memorable gifts for their gift recipients. In many situations, users have to dig through huge number of items provided by the interact to find desirable gifts.

### BRIEF DESCRIPTION OF DRAWINGS

The present disclosure is illustrated by way of example and not limitation in the figures of the accompanying drawings, in which like references indicate similar elements and in which:

FIG. 1 is an overview diagram illustrating a network system configured to recommend gifts to a user for a gift recipient according to an example embodiment;

FIG. 2 is a more detailed diagram illustrating the network system as shown in FIG. 1 according to an example embodiment;

FIG. 3 is a simplified block diagram illustrating modules included in a gift recommendation system within the network system as shown in FIG. 2 according to an example embodiment;

FIG. 4 is a simplified diagram illustrating a graphical user interface (GUI) configured to input information of a gift recipient according to an example embodiment;

FIG. 5 is a simplified diagram illustrating a GUI configured to present gift categories according to an example embodiment;

FIG. 6 is a simplified diagram illustrating a GUI configured to present gift items according to an example embodiment;

FIG. 7 is a flow diagram illustrating a method of recommending gifts to a user for a gift recipient according to an example embodiment; and

FIG. 8 is a block diagram illustrating a machine in an example form of a computer system according to an example embodiment.

### DETAILED DESCRIPTION

In the following description, for purposes of explanation, numerous specific details are set forth in order to provide a thorough understanding of example embodiments. It will be evident, however, to one skilled in the art that the embodiments of the application may be practiced without these specific details.

The term “gift” in the following description denotes a “product” sent from a user to his or her gift recipient. The “product” here can be either a physical product (such as a laptop computer) or a service (such as a fitness training program).

Embodiments for recommending gifts to users for their gift recipients over a network are described. An exemplary gift recommendation system may collect a set of historical transaction data of a plurality of transactions, and organize the set of historical transaction data based on information related to buyer gender, buyer age, item category, and transaction date of each transaction.

In some embodiments, the gift recommendation system may retrieve gender and age information of a gift recipient via a graphical user interface for example. The gift recommendation system then may automatically present a list of gift categories (or interests) selected from the organized set of historical transaction data based on the retrieved gender and age information of the gift recipient. The list of gift categories may have a predetermined number of categories. In some embodiments, the gift recommendation system may analyze the set of historical transaction data to determine the rank of the categories in the list of gift categories based on an entire item purchase amount of each gift category.

In some embodiments, once a gift category being selected from the presented list of gift categories, the gift recommendation system may automatically present a list of gift items belonging to the selected gift category. The list of gift items may have a predetermined number of gift items. In some embodiments, the gift recommendation system may analyze the set of historical transaction data to determine the rank of the gift items in the list of gift items based on an entire item purchase amount of each gift item.

In some embodiments, once a specific gift category within the list of gift categories being found to have a recent abrupt increase of item purchase amount, the specific gift category is presented on a high rank in the list of predetermined amount of gift categories.

In some embodiments, once a specific gift item within the list of gift items being found to have a recent abrupt increase of item purchase amount, the specific gift item is presented on a high rank in the list of predetermined amount of gift items.

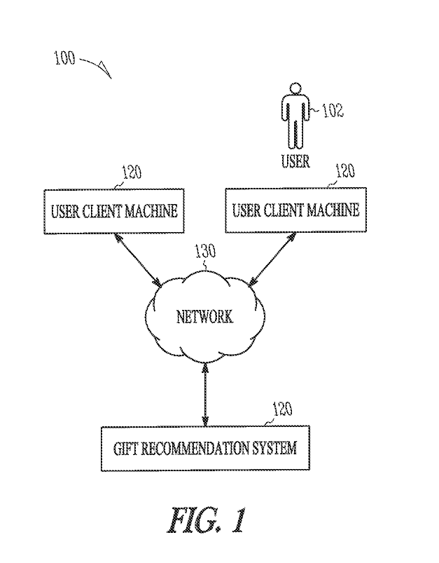

FIG. 1 is an overview diagram illustrating a network system 100 configured to recommend gifts to users 102 for their gift recipients (not shown) according to an example embodiment. The network system 100 includes a gift recommendation system 110 and one or more user client machines 120 accessible to users 102. The gift recommendation system 110 and the one or more user client machines 120 are all coupled to a network 130. The gift recommendation system 110 may recommend gifts to a user 102 accessing to one of the user client machines 120 for his or her gift recipient.

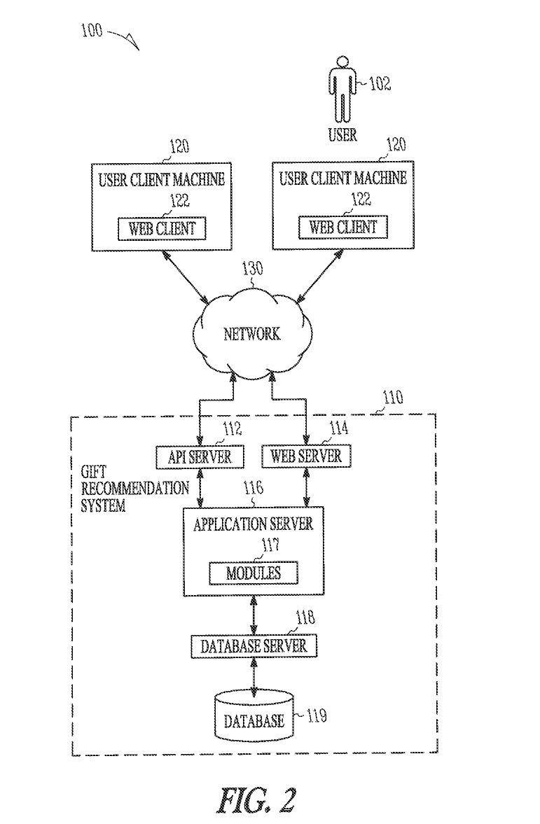

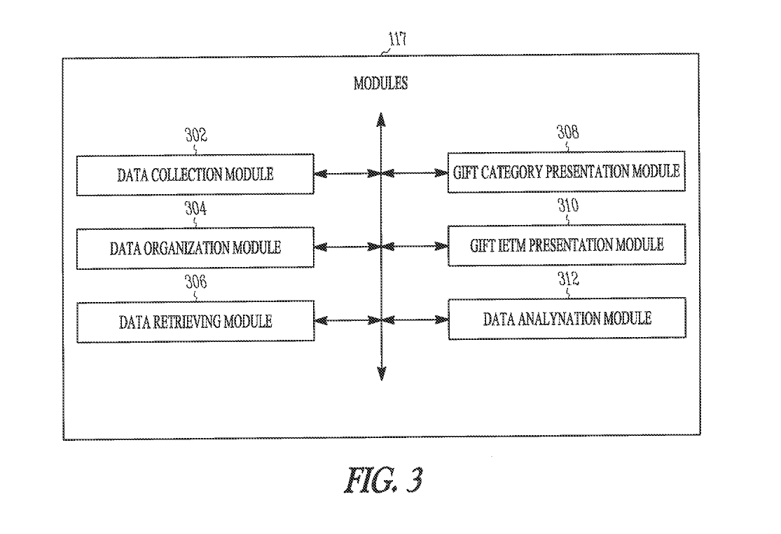

FIG. 2 is a more detailed diagram illustrating the network system 100 as shown in FIG. 1 configured to recommend gifts to a user 102 for a gift recipient over the network 130 according to an example embodiment. The gift recommendation system 110 of the network system 100 includes an application server 116, an application program interface (API) server 112, and a web server 114. The API server 112 and the web server 114 are coupled to the application server 116 and provide programmatic interface and web interface to the application server 116. The application server 116 includes a number of modules 117 (as shown in FIG. 3), and is coupled to one or more database servers 118 that facilitate access to one or more databases 119.

It should be noted that the network system 100 as shown in FIGS. 1 and 2 employs a client-server architecture. The term “client-server” denotes a model of interaction in a distributed computer system in which a program at one site sends a request to a program at another site and waits for a response. The requesting program is called the “client,” and the program that responds to the request is called the “server.” However, embodiments of the present application are not limited to such a client-server architecture, and could equally well find application in other kinds of architectures, for example, a distributed architecture or a peer-to-peer architecture.

The gift recommendation system 110 forms a platform, which may receive and/or transmit information (e.g., gender and/or age information of a gift recipient, list of gift categories, and list of gift items) from and/or to one or more clients, and may also provide server-side functionalities to one or more clients over the network 130. The information received and/or transmitted by the gift recommendation system 110 may include, but is not limited to, information related to gender, age and interests of a gift recipient, list of gift categories, and a list of gift items presented to the user 102 for his or her gift recipients.

FIG. 3 is a simplified block diagram illustrating modules 117 included in the application server 116 of the gift recommendation system 110 in accordance with an example embodiment. The application server 116 may provide a number of modules 117, which provide functions and services to users of the seller system 110. For example, the modules 117 may include, but are not limited to, a data collection module 302, a data organization module 304, a data retrieving module 306, a gift category presentation module 308, a gift item presentation module 310, and a data analyzation module 312.

In some embodiments, the data collection module 302 of the gift recommendation system 110 may collect a huge set of historical transaction data and purchaser data related to a huge amount of various products, and maintain a large database (or data warehouse) 119 to store the huge set of collected historical transaction data and purchaser data. The term “product” denotes either a physical product or a service. For example, a product can be a physical product, such as a laptop computer, and can also be a service, such as a fitness training program,

In some embodiments, the data organization module 304 of the gift recommendation system 110 may organize the set of historical transaction data stored in the data warehouse 119 based on information related to, for example, purchaser gender, purchaser age, item categories, and transaction dates of the historical transactions. In the data warehouse 119, purchasers are divided into different groups by the gender and age.

For example, the data organization module 304 of the gift recommendation system 110 may build and maintain a “Historical_Transaction” table, which includes columns such as “Buyer_Id”, “Item_Id”, “Category_Id” as shown below:

“Historical_Transaction” Table

| | | | |
|---|---|---|---|
| Buyer_Id | Item_Id | Category_Id | . . . |

The data organization module 304 of the gift recommendation system 110 may also build and maintain a “Buyer” table, which includes columns such as “Buyer_id”, “Buyer_Age”, and “Buyer_Gender” as shown below:

“Buyer” Table

| | | | |
|---|---|---|---|
| Buyer_Id | Buyer_Age | Buyer_Gender | . . . |

Thus, in virtue of the historical transaction and purchaser data maintained in the data warehouse 119, by mapping the above “Historical_Transaction” and “Buyer” tables, the data organization module 304 of the gift recommendation system 110 may obtain a list of ranked purchase categories associated with each purchaser group having the same age and gender. In such a way, each purchaser group is mapped to a list of ranked product (gift) categories. The organized historical transaction data may be used to recommend gifts to a user for a gift recipient.

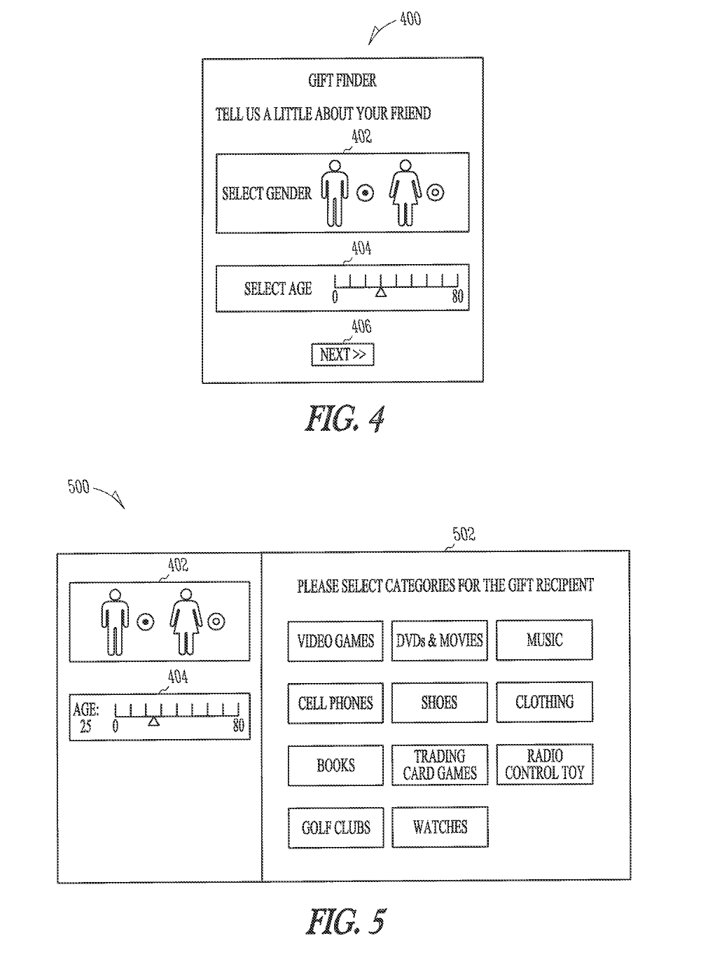

In some embodiments, the data retrieving module 306 of the gift recommendation system 110 may retrieve gender and age information associated with a gift recipient from an input from a user 102 via a GUI. As shown in FIG. 4, the GUI 400 is loaded onto the user client machine 120, and is configured to receive a gift recipient's gender and age information from the user 102. For example, the user 102 may select “Male” radio button in “Select Gender” block 402, and select “30” as the age of the gift recipient in “Select Age” block 404. The user 102 may then click “Next” button 406 to enter the gift recipient's gender and age information, which is then transmitted to the data retrieving module 306 of the gift recommendation system 110.

In some embodiments, the data retrieving module 306 of the gift recommendation system 110 may retrieve gender and age information associated with a gift recipient from other resources, for example, from the output of another application program.

In some embodiments, the whole gift recommendation system 110 or the data retrieving module 306 of the gift recommendation system 110 can be developed into a framework of a social networking website (such as Facebook, MySpace, and Friendster) to interact with core features of the social networking website.

For example, with the data retrieving module 306 of the gift recommendation system 110 developed into the framework of Facebook, the user 102 of the user client machine 120 can obtain his or her friend's gender and age information from the friend's profile. Thus, there is no need for the user 102 to enter the friend's gender and age information. The user 102 may also obtain the friend's interest information from the Facebook applications. For example, from the friend's Facebook profile, the user 102 may notice that the friend often writes reviews on movies and has installed many travel related applications, and thus may guess that the friend might be interested in watching movie and traveling. Such friend's interest information is helpful to recommend gifts for the friend more accurately. In addition, the user 102 may also take an advantage of the Facebook to obtain a remainder of the friend's birthday.

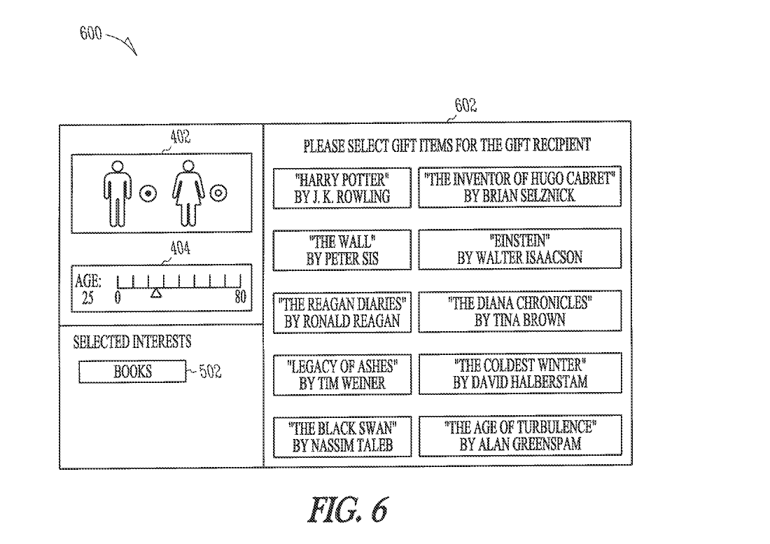

FIG. 5 is a simplified diagram illustrating a GUI 500 configured to present a list of gift categories 502. that most likely match the interests of the gift recipient according to an example embodiment. Each category may be listed as a link along with a photo or an image (not shown).

In some embodiments, once the gender and age information of a gift recipient is retrieved by the data retrieving module 306 of the gift recommendation system 110, the gift category presentation module 308 of the gift recommendation system 110 may obtain a list of ranked categories (or interests) associated with the age and gender information of the gift recipient, and then automatically present the list of categories (or interests) to the user 102 based on the retrieved age and gender information of the gift recipient. In some embodiments, the gift recommendation system 110 may set a predetermined number of categories to be presented to the user 102, for example, 15.

As shown in FIG. 5, for example, for a male gift recipient aged 25, the gift category presentation module 308 of the gift recommendation system 110 may present a list of following ranked categories or interests to a user 102:

Video Games

DVDs & Movies

Music

Cell Phones

Shoes

Clothing

Books

Trading Card Games

Radio Control Toy

Golf Club

Watches

In another example (not shown in figures), for a female gift recipient aged 35, the gift category presentation module 308 of the gift recommendation system 110 may present a list of following ranked categories or interests to a user 102:

DVDs & Movies

Shoes

Handbags

Clothing

Books

Music

Jewelry

Cell Phones

Stuffed Animals

Crafts

Health & Beauty

In some embodiments, the data analyzation module 312 of the gift recommendation system 110 may analyze the set of historical transaction data in the data warehouse to determine the rank of the categories or interests in the presenting list of gift categories based on an entire item purchase amount of each gift category.

In some embodiments, once the data analyzation module 312 of the gift recommendation system 110 finds that a specific gift category within the presenting list of gift categories has experienced a recent abrupt increase of item purchase amount, the gift category presentation module 308 may automatically present the specific gift category on a high rank in the presenting list of gift categories. For example, once the data analyzation module 312 of the gift recommendation system 110 finds that stationery items (such as student notebooks, student pens) belonging to a “back-to-school” category within the presenting list of gift categories has experienced a recent abrupt increase of item purchase amount, the gift category presentation module 308 may automatically present the specific “back-to-school” gift category (a seasonal gift category) on a high rank in the presenting list of gift categories.

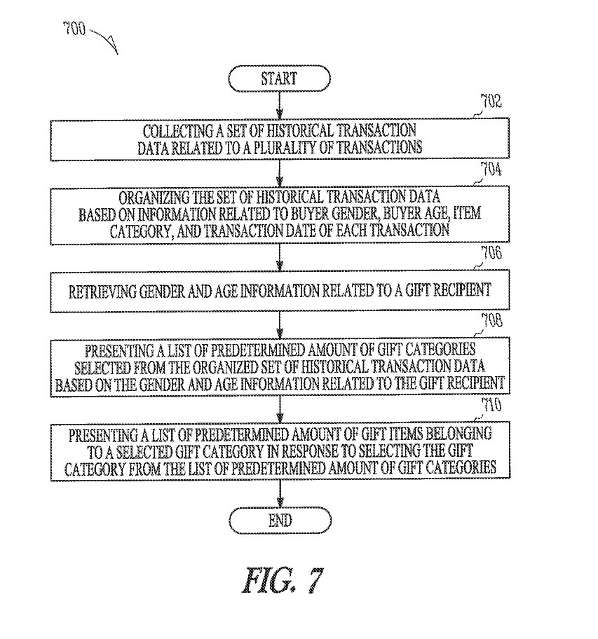

FIG. 6 is a simplified diagram illustrating a GUI 600 configured to present a list of gift items 602 based on selected one or more gift categories according to an example embodiment, Each gift item may be listed along with a photo or an image.

In some embodiments, once a gift category (or interest) is selected from the list of gift categories, the gift category item module 310 of the gift recommendation system 110 may present a list of gift items. In some embodiments, the gift recommendation system 110 may set a predetermined number of items to be presented to the user 102, for example, 20. In some embodiments, the list of predetermined amount of gift items is ordered based on an entire item purchase amount of each gift item.

As shown in FIG. 6, for a male gift recipient aged 25, once a gift category “Books” is selected, the gift item presentation module 310 of the gift recommendation system 110 may present a list of ranked book items 602 to a user 102 based on the statistics of the set of the historical transaction data.

“Harry Potter” by J. K. Rowling

“The Invention of Hugo Cabret” by Brian Selznick

“The Wall” by Peter Sis

“Einstein” by Walter Isaacson

“The Reagan Diaries” by Ronald Reagan

“The Diana Chronicles” by Tina Brown

“Legacy of Ashes” by Tim Weiner

“The Coldest Winter” by David Halberstam.

“The Black Swan” by Nassim Taleb

“The Age of Turbulence” by Alan Greenspan

“The Assault on Reason” by Al Gore

“Lone Survivor” by Marcus Luttrell

In some embodiments, the data analyzation module 312 of the gift recommendation system 110 may analyze the set of historical transaction data in the data warehouse to determine the rank of the items in the presenting list of gift items based on an entire item purchase amount of each gift item.

FIG. 7 is a flow diagram illustrating a method 700 of recommending gifts to a user 102 for a gift recipient according to an example embodiment.

At 702, a huge set of historical transaction data and purchaser data related to a huge amount of various products is collected by a data collection module 302 of the gift recommendation system 110. The huge set of historical transaction data and purchaser data is maintained for example in a large database (or data warehouse) 119 of a gift recommendation system 110 of the network system 100.

At 704, the huge set of historical transaction data is organized by a data organization module 304 of the gift recommendation system 110 based on information related to buyer gender, buyer age, item category, and transaction date of each transaction. For example, in the data warehouse 119, purchasers of products are divided into different groups by their gender and age.

At 706, gender and age information related to a gift recipient is retrieved by a data retrieving module 306 of the gift recommendation system 110. in some embodiments, the gender and age information related to a gift recipient may be retrieved from a user input via a GUI 300 as shown in FIG. 1. The gender and age information related to the gift recipient may also be retrieved from another application program. In some embodiments, with the data retrieving module 306 of the gift recommendation system 110 developed into a framework of a social networking website (for example, Facebook), the gender and age information related to the gift recipient may be retrieved from the gift recipient's profile in Facebook.

At 708, once the gender and age information of the gift recipient is received, a list of gift categories is presented by a gift category presentation module 308 of the gift recommendation system 110 to the user 102. The list of gift categories is selected from the organized set of historical transaction data based on the retrieved gender and age information of the gift recipient. In some embodiments, a predetermined number of categories (for example 15) presented to the user 102 is set.

In some embodiments, the set of historical transaction data in the data warehouse may be analyzed to determine the rank of the categories in the presenting list of gift categories based on an entire item purchase amount of each gift category.

In some embodiments, once it is found that a specific gift category within the presenting list of gift categories has experienced a recent abrupt increase of item purchase amount, the specific gift category will be presented on a high rank in the presenting list of gift categories. For example, once it is found that stationery items (such as student notebooks, student pens) belonging to a “back-to-school” category within the presenting list of gift categories has experienced a recent abrupt increase of item purchase amount, the specific “back-to-school” gift category (a seasonal gift category) will be automatically presented on a high rank in the presenting list of gift categories.

At 710, once a gift category is selected from the list of gift categories, a list of gift items belonging to the selected gift category is presented by a gift item presentation module 310 of the gift recommendation system 110 to the user 102. In some embodiments, a predetermined number of gift items (for example 20) presented to the user 102 is set,

In some embodiments, the set of historical transaction data in the data warehouse may be analyzed to determine the rank of the items in the presenting list of gift items based on an entire item purchase amount of each gift item.

In some embodiments, once it is found that a specific gift item within the presenting list of gift items has experienced a recent abrupt increase of item purchase amount, the specific gift item will be presented on a high rank in the presenting list of gift items. For example, once it is found that a “notebook” item belonging to a “back-to-school” category has experienced a recent abrupt increase of item purchase amount, the specific “notebook” gift item will be presented on a high rank in the presenting list of gift items belonging to the “back-to-school” category.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

Thus, the methods described herein may be performed by processing logic that comprises hardware (e,g., dedicated logic, programmable logic), firmware (e.g., microcode, etc.), software (e.g., algorithmic or relational programs run on a. general purpose computer system or a dedicated machine), or any combination of the above, It should be noted that the processing logic may reside in any of the modules described herein.

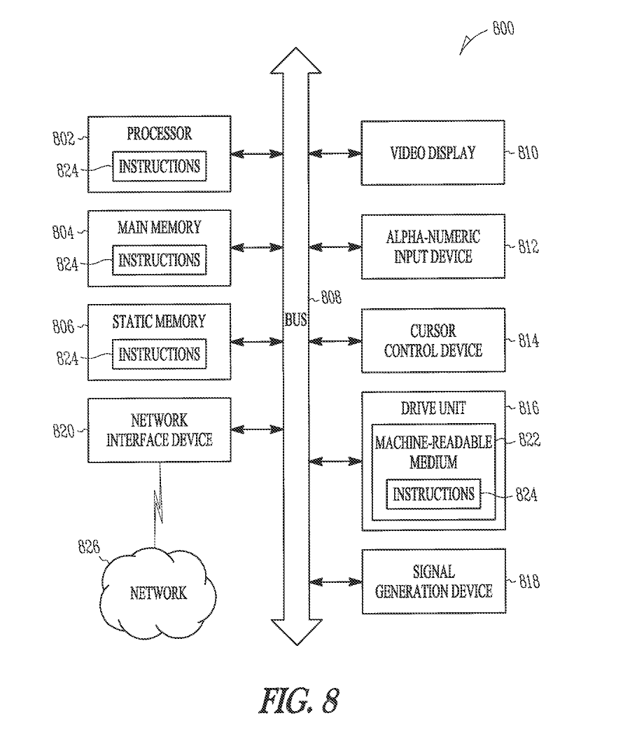

FIG. 8 is a block diagram illustrating a machine in an example form of a computer system 800 according to an example embodiment, within which a set of sequence of instructions for causing the machine to perform any one of the methodologies discussed herein may be executed,

In alternative embodiments, the machine may be a server computer, a. client computer, a personal computer (PC), a tablet PC, a set-top box (STB), a Personal Digital Assistant (PDA), a cellular telephone, a web appliance, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 800 includes a processor 802 (e.g., a central processing unit (CPU) a graphics processing unit (GPU) or both), a main memory 804 and a static memory 806, which communicate with each other via a bus 808. The computer system 800 may further include a video display unit 810 (e,g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824 ) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application. The term “machine-readable medium” shall accordingly be taken to include, but not be limited to, solid-state memories, optical and magnetic media.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information),

Thus, methods and systems for recommending gifts have been described. Although the present application has been described with reference to specific embodiments, it will be evident that various modifications and changes may be made to these embodiments without departing from the broader spirit and scope of the application. Accordingly, the specification and drawings are to be regarded in an illustrative rather than a restrictive sense.

The Abstract of the Disclosure is provided to comply with 37 C.F.R. §1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the Wowing claims are hereby incorporated into the Detailed Description, with each claim standing on its as a separate embodiment.

What is claimed is:

1. A system comprising:
one or more memories coupled to at least one processor and storing modules comprising:
a data retrieving module to retrieve gender and age information of a gift recipient;
a gift category presentation module to present a predetermined number of gift categories corresponding to interests of the gift recipient; and
a gift item presentation module to present, in response to a user selection of at least one gift category of the predetermined number of gift categories, a list of gift items belonging to the respective selected gift categories and selected based on the age and gender information of the gift recipient.

2. The system of claim 1, wherein the gender and age information is retrieved from a user input via a graphical user interface.

3. The system of claim 1, wherein the gender and age information is retrieved from a third party application.

4. The system of claim 3, wherein the third party application is a social networking website.

5. The system of claim 1, wherein the data retrieving module is further to retrieve interests of the gift recipient from a social networking website.

6. The system of claim 1, further comprising a data analyzation module to rank the predetermined number of gift categories based on an entire item purchase amount by a plurality of purchasers for each selected gift category, and wherein the predetermined number of gift categories is presented in an order based on the ranking.

7. The system of claim 6, wherein the data analyzation module is further to rank the list of gift items based on an entire item purchase amount of each gift item of a plurality of purchasers and wherein the list of gift items is presented in an order based on the ranking.

8. The system of claim wherein he predetermined number of gift categories is the user selection.

9. A method of recommending gifts, comprising:
retrieving gender and age information of a gift recipient;
presenting a list of gift categories corresponding to interests of the gift recipient;
receiving a selection of at least one gift category from the list of gift categories;
selecting, using one or more processors, in response to receiving the selection of at least one gift category from the list of gift categories, a list of gift items belonging to the respective selected gift categories, the selecting of the list of gift items being based on the gender and age information of the gift recipient; and
presenting the list of gift items to the user.

10. The method of claim 9, wherein data retrieving module comprises a graphical user interface configured to retrieve the gender and age information of the gift recipient.

11. The method of claim 9, wherein the data retrieving module is configured to retrieve the gender and age information of the gift recipient from a third party application.

12. The method of claim 11, wherein the third party application is a social networking website.

13. The method of claim 9, further comprising obtaining interest information of the gift recipient from the social networking website.

14. The method of claim 9, further comprising obtaining a reminder of a birthday of the gift recipient from the social networking website.

15. The method of claim 9, further comprising ranking, by the processor, the selected list of gift categories based on an entire item purchase amount by a plurality of purchasers for each selected gift category and wherein the list of gift categories are presented in an order based on the ranking.

16. The method of claim 9, further comprising ranking, by the processor, the selected list of gift items based on an entire item purchase amount of each gift item by a plurality of purchasers and wherein the list of gift items is presented in an order based on the ranking.

17. A non-transitory machine-readable medium storing instructions, which when executed by one or more processors, cause the one or more processors to perform operations, comprising:
retrieving gender and age information of a gift recipient;
presenting a list of gift categories corresponding to interests of the gift recipient;
receiving a selection of at least one gift category from the list of gift categories;
selecting, by a processor, in response to receiving the selection of at least one gift category, a list of gift items belonging to each of the selected gift categories, the selecting being based on the gender and age information of the gift recipient; and
presenting the list of gift items to the user.

18. The non-transitory machine-readable medium of claim 17, wherein the gender and age information of the gift recipient is retrieved from a graphical user interface.

19. The non-transitory machine-readable medium of claim 17, further comprising obtaining interest information of the gift recipient from a social networking website.

20. The non-transitory machine-readable medium of claim 17, further comprising ranking, by the processor, the selected list of gift items based on an entire item purchase amount of each gift item by a plurality of purchasers and wherein the list of gift items is presented in an order based on the ranking.
